(19) United States
(12) Patent Application Publication
(10) Pub. No.: US 2019/0352951 A1
(43) Pub. Date: Nov. 21, 2019

(54) HINGE PIN SUPPORT

(71) Applicant: Christopher James Howson, Northwood, ND (US)

(72) Inventor: Christopher James Howson, Northwood, ND (US)

(21) Appl. No.: 15/979,698

(22) Filed: May 15, 2018

(51) Int. Cl. E05D 11/00; E05D 3/02; E05D 5/12; A63B 21/055; A63B 21/04

(52) U.S. Cl. CPC E05D 11/00; E05D 3/02; E05D 5/128; E05D 2005/102; A63B 21/0442; E05Y 2900/132; A63B 21/0557

(57) ABSTRACT

A hinge pin support for a resistance band can include a cylindrical body and an eye. The cylindrical body can extend along a longitudinal axis and can include a first end portion and an opposite second end portion. The cylindrical body can be insertable into a set of knuckles of a door hinge. The eye can connect to a resistance band. The eye can be coupled to a first end portion of the cylindrical body and can extend radially outward from the cylindrical body.

### BACKGROUND

The present invention relates generally to resistance band supports and more specifically to door anchors for resistance bands. Physicians or trainers frequently direct or prescribe patient or client use of resistance bands for strengthening and stretching of various muscles and soft tissues. To function properly, resistance bands require temporary or permanent fixation to a rigid item, such as a wall or heavy support, for example, a steel power rack frame frequently found in gyms.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1A shows a perspective view of a pin support secured to a door hinge, in accordance with an example of the present disclosure.

FIG. 1B shows a perspective view of a pin support secured to a door hinge, in accordance with an example of the present disclosure.

FIG. 2 shows a perspective view of a pin support secured to a door hinge, in accordance with an example of the present disclosure.

FIG. 3 illustrates an isometric view of a pin support, in accordance with at least one example of this disclosure.

FIG. 4 illustrates an isometric view of a pin support, in accordance with at least one example of this disclosure.

FIG. 5 illustrates a schematic of a method, in accordance with at least one example of this disclosure.

### DETAILED DESCRIPTION

In some cases, physicians or trainers direct or prescribe patient use of resistance bands for strengthening and stretching of various muscles and soft tissues. Door anchors have been used as a low-cost solution for anchoring resistance bands. Door anchors can be especially useful for patients in need of daily or frequent rehab or training sessions because they allow prescribed exercises or movements to be performed at home or anywhere a door can be found. However, current door anchors require that a door be opened for insertion of the anchor and be closed to secure the anchor between the door and the door frame. This means the door cannot be effectively opened during use of the resistance band and/or the door anchor must be re-secured to the door after each time that the door is opened.

This disclosure provides a solution to these issues by providing a pin support configured to replace a hinge pin of a hinge of a door. The door hinge pin can be removed and the pin support can be inserted into knuckles of the hinge. A body of the pin support can be fastened or secured within the hinge to prevent accidental displacement of the hinge support from the hinge knuckles. For example, a shackle, hook, or carabiner can be secured to an eye of the pin support where the eye and/or carabiner can be configured to releasably retain a resistance band. Further details and benefits of this disclosure are discussed with respect to the FIGS. below.

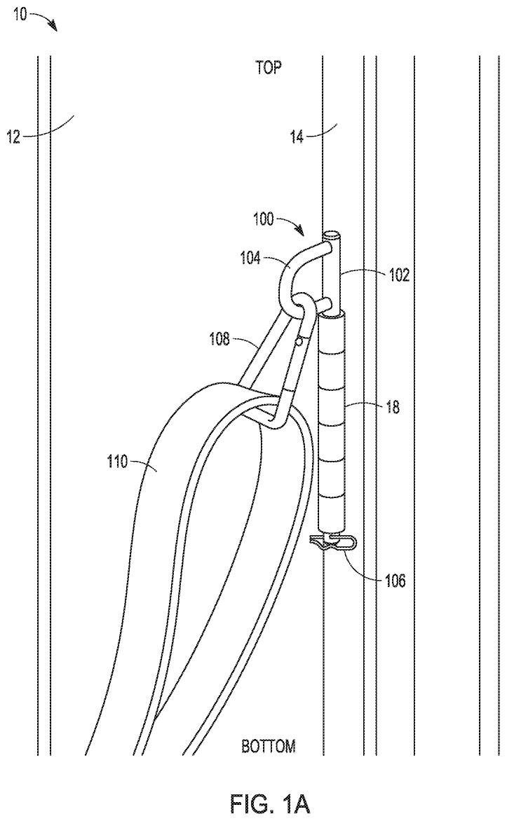

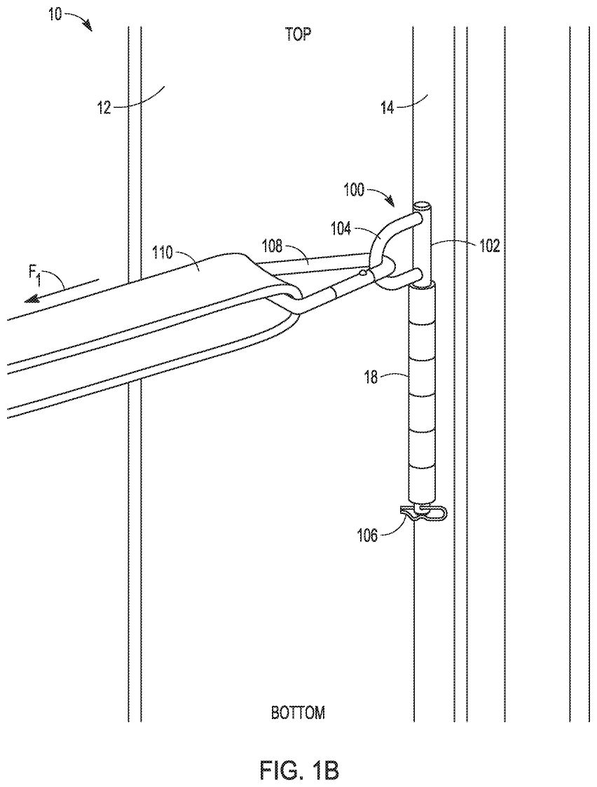

FIG. 1A shows a perspective view of system 10 including pin support 100 secured to door hinge 18 to support resistance band 110 in a first condition, in accordance with an example of the present disclosure. FIG. 1B shows a perspective view of system 10 including pin support 100 secured to door hinge 18 to support resistance band 110 in a second condition, in accordance with an example of the present disclosure, in accordance with an example of the present disclosure. FIGS. 1A and 1B are discussed below concurrently.

System 10 includes door 12, door frame 14, hinge 18, and pin support 100. Pin support 100 includes cylindrical body 102, eye 104, fastener 106, and coupler 108. Also shown in FIGS. 1A and 1B are resistance band 110 and orientation indicators Top and Bottom. Also shown in FIG. 1B is force F1.

Door 12, door frame 14, and hinge 18 can be components of a typical door in an entryway to a room, house, or area in a residential, commercial, or office. Door 12 can be mounted on hinge 18, which in turn can be secured to door frame 14. Door frame 14 can be secured to one or more walls. Door 12 can be mounted on multiple hinges, such as 1, 2, 3, 4, 5, or the like hinges. Door 12 can be pivotable about hinge 18 to open and close.

Pin support 100 can be a support configured to secure resistance band 110 to door 12 and door frame 14 using hinge 18. In some examples, pin support 100 can include body 102 (e.g., cylindrical body 102), which can be inserted within knuckles of hinge 18 in place of a hinge pin, such that door 12 can rotate about hinge 18 when pin support 100 is installed in knuckles of hinge 18.

Eye 104 can be a loop or eye connected to a top portion (or a first or second portion) of cylindrical body 102 and can be sized to receive resistance bands therethrough. Eye 104 can also be sized and shaped to receive coupler 108, which can releasably secure resistance band 110 to eye 104 (and therefore to body 102), as shown in FIG. 1A. While eye 104 is illustrated with a U-shaped configuration, eye 104 can take the form of other shapes (e.g., v-shaped, similar to the shape of coupler 108).

Fastener 106 can be a pin or other fastener configured to be secured to a bottom portion (or a first or second portion) of body 102 to secure body 102 within hinge 18. Though coupler 108 is discussed as receiving and securing resistance band 110 to eye 104, eye 104 can directly receive resistance band 110 therein, in some examples.

In operation of some examples, a force, such as force F1 of FIG. 1B, can be applied to resistance band 110 by a user, such as by pulling on resistance band 110. Resistance band 110 can transmit force F1 to coupler 108, which can transfer the transmitted force to eye 104 and body 102 of pin support 100. Body 102 can transfer the force to hinge 18 which can disperse the force to door frame 14, where door frame 14 can transmit a reaction force back to resistance band 110. This allows a user to receive a reaction force from resistance band 110 in a direction substantially opposite to force F1. In some examples, force F1 can be reduced and/or eliminated by the user and then reapplied as the user performs repetitions. With the resistance band 110 coupled to the door frame 14 via the hinge 18, the door 12 is free to move with the resistance band 110 in place. Further details and operations of pin support 100 are discussed in further detail below.

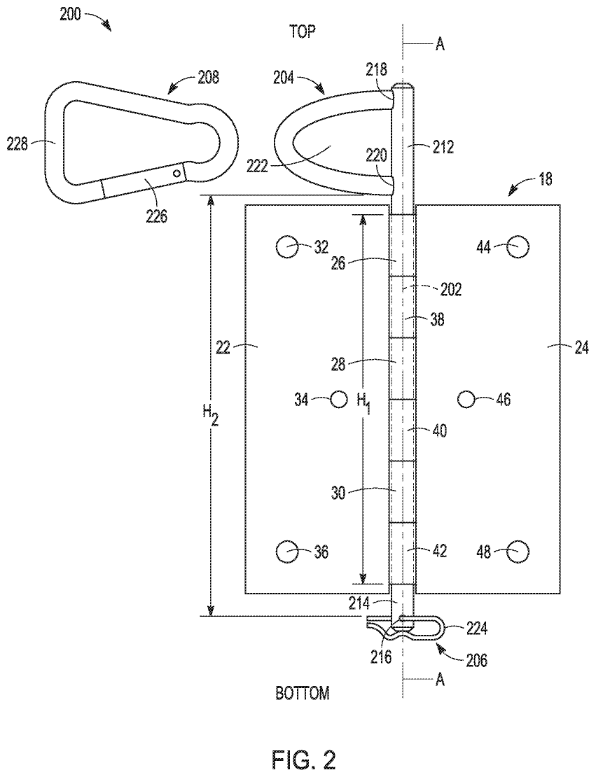

FIG. 2 shows a perspective view of pin support 200 secured to door hinge 18, in accordance with an example of the present disclosure. Pin support 200 can include body 202, eye 204, and fastener 206. Cylindrical body 202 can include top portion 212 and bottom portion 214. Bottom portion 214 can include fastener bore 216. Eye 204 can include top arm 218, bottom arm 220, and opening 222. Fastener 206 can include head 224. Coupler 208 can include gate 226 and frame 228. Hinge 18 can include left leaf 22 and right leaf 24. Left leaf 22 can include knuckles 26, 28, and 30 and can include bores 32, 34, and 36. Right leaf can include knuckles, 38, 40, and 42 and can include bores 44, 46, and 48. Also shown in FIG. 2 are axis A, heights H1 and H2, and orientation indicators Top, Bottom, Left, and Right.

Cylindrical body 202 can be a rigid or semi-rigid and elongate body comprised of materials such as metals, plastics, foams, elastomers, ceramics, composites, and combinations thereof. Cylindrical body 202 can extend from top to bottom along a longitudinal axis, such as axis A. Cylindrical body 202 can include top portion 212 which can be a top portion of body 202 and bottom portion 214 which can be a bottom portion of body 202. Cylindrical body 202 can have a cylindrical shape, in some examples, such that cylindrical body 202 can be disposed within knuckles (discussed below) of hinge 18 and can serve has a fastener for the knuckles and can serve as a bearing of hinge 18. In some examples, cylindrical body 202 can have different diameters and heights to accommodate hinges of various sizes. For example, cylindrical body 202 can have a diameter of 0.5 centimeters (cm) and a height of 8 cm. In some examples, cylindrical body 202 can have a diameter of about 0.1 cm to about 1.5 cm. In other examples, cylindrical body 202 can have a diameter of about 0.3 cm to about 0.6 cm. In some examples, cylindrical body 202 can have a height of about 1 cm to about 15 cm. In other examples, cylindrical body 202 can have a height of about 6 cm to about 11 cm.

Fastener bore 216 can be a bore extending through bottom portion 214 of cylindrical body 202. In some examples, fastener bore 216 can be substantially orthogonally to axis A. In other examples, fastener bore 216 can be at other angles with respect to axis A through bottom portion 214. As discussed further below, fastener bore 216 can be configured to receive fastener 206 therein.

Eye 204 can be an eye connector coupled to top portion 212 of cylindrical body 202 and can, for example, extend radially outward from cylindrical body 202. Top arm 218 and bottom arm 220 can form a loop or eye and can be individually welded or secured to body 202 to form opening 222, where opening 222 can be sized to receive a resistance band therein, in some examples. Top arm 218 can be coupled to top portion 212 near a top end of top portion 212 and bottom arm 220 can be coupled to top portion 212 below the top end and below top arm 218. In some examples, eye 204 can be formed of a single piece with body 202 (such as a welded eye bolt). In other examples, eye 204 can be fastened to body 202 using screws, rivets, bolts, welds, and the like. In another example, eye 204 can be a loop attached to a top end of a cylindrical tube.

Fastener 206 can be a fastener securable to fastener bore 216. In some examples, fastener 206 can be a pin, such as a cotter pin or R-clip. In other examples, fastener 206 can be a screw, nut, bolt, rivet, clip, or other fastener. Head 224 can be a head or end loop of fastener 206. In some examples, head 224 can be sized to allow fastener 206 to hang vertically from fastener bore 216 when head 224 of fastener 206, such as a cotter pin head, is inserted into fastener bore 216.

Coupler 208 can be a shackle or hook such as a carabiner. In other examples, coupler 208 can be other types of hooks or shackles such as an S-hook, J-hook, bow shackle, D-shackle, twist shackle, or the like. In an example where coupler 208 is a carabiner, coupler 208 can include gate 226, which can be pivotably coupled to frame 228. In some examples, frame 228 can be sized and shaped to receive therein one or more of a plurality of resistance bands of various sizes.

Hinge 18 can be a door hinge configured for mounting to doors, in some examples. Knuckles 26, 28, and 30 can be substantially cylindrical extensions of left leaf 22 extending to the right therefrom where each of knuckles 26, 28, and 30 can be substantially coaxial with axis A and can be spaced to receive a knuckle of right leaf 24 therebetween. Similarly, knuckles 38, 40, and 42 can be substantially cylindrical extensions of right leaf 22 extending to the left therefrom where each of knuckles 38, 40, and 42 can be substantially coaxial with axis A and can be spaced to receive a knuckle of left leaf 22 therebetween such that knuckles 26, 28, and 30 interlock in a finger-lock type arrangement with knuckles 38, 40, and 42 such that all of knuckles 26, 28, and 30 are substantially coaxial with knuckles 38, 40, and 42 and with axis A and can receive body 202 therein.

Each of left leaf 22 and right leaf 24 can include a plurality of bores (bores 32, 34, and 36 and bores 44, 46, and 48, respectively), which can be sized and shaped to receive a fastener therethrough to secure leaves 22 and 24 to a door and doorframe, respectively.

In operation of some examples, after a hinge pin is removed from knuckles 26, 28, and 30 and knuckles 38, 40, and 42, body 202 can be axially aligned with the knuckles and inserted therethrough from top to bottom. In some examples, eye 204 can be positioned on cylindrical body 202 such that bottom arm 220 can have a height H2 from fastener bore 216 that is larger than height H1 of the knuckles. More specifically, when bottom arm 220 contacts a top-most knuckle, such as knuckle 26 of left leaf 22, to limit downward translation of cylindrical body 202 with respect to knuckles 26, 28, 30, 38, 40, and 42 (set of knuckles), eye 204 is located above knuckle 26 and fastener bore 216 is located below of bottom knuckle 42 of right leaf 24 allowing fastener 206 to be inserted through fastener bore 216. After body 202 is fully inserted into hinge 18, fastener 206 can be inserted into fastener bore 216 of bottom portion 214 of body 202. When inserted, fastener 206 can be engageable with bottom knuckle 42 to limit upward (or lateral or axial) translation of cylindrical body 202 with respect to the set of knuckles and hinge 18 generally.

After body 202 is fully inserted into hinge 18, body 202 can function as a bearing for hinge 18, allowing hinge 18 to operate as a normal door hinge, because cylindrical body 202 can be sized to secure knuckles of left leaf 22 to knuckles of right leaf 24, and can be sized to rotate about axis A while inserted in the set of knuckles. Accordingly, eye 214 can rotate with body 202 relative to knuckles 26, 28, 30, 38, 40, and 42 to help avoid contact between eye 214 and a door and door frame, to help allow free rotation of a door relative to a door frame (such as door 12 and door frame 14). Also, because fastener 206 can hang vertically from fastener bore 216, contact between fastener 206 and a door and door frame (such as door 12 and door frame 14) can be reduced. Pin support system 200 can be used whether the door is open or closed. In either position, eye 214 and the resistance band (and optional coupler 208) freely rotate relative to the door and door frame, allowing a user to use the resistance bands whether the door is open or closed. In addition, the door can, for example, be opened and closed without any part of the resistance band system being removed.

Though hinge 18 is discussed above as being a door hinge secured to a wall, hinge 18 can be a hinge secured to a vehicle, appliance, or any other item using a hinge. In some examples, only half of hinge 18 can be used to receive body 202 of pin support 200, such as leaf 24. This can be useful where a door has been removed from a doorway or where a half of a hinge is attached to a rigid member such as a steel frame of exercise equipment. Also, though hinge 18 is shown as having six knuckles, hinge 18 can include 2, 3, 4, 5, 7, 8, 9, 10, 11, 12 or the like knuckles in other examples.

Though eye 214 is described as being connected to top portion 212, eye 214 can be connected to bottom portion 214 in other examples, such that top portion 212 receives a fastener therethrough. In other examples, pin support 200 can be inserted upside down so that fastener 216 is on top.

In some examples, pin support 200 can include multiple eyes. For example, a second eye can be connected above (on top of eye 204). In other examples, one or more eyes can be connected next to eye 204 in a radial direction.

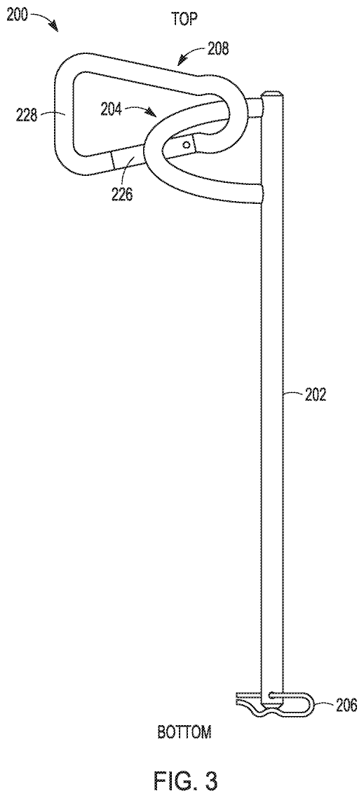

FIG. 3 illustrates an isometric view of pin support 200, in accordance with at least one example of this disclosure. Pin support 200 can be consistent with pin support 200 of FIG. 2; however, FIG. 3 shows pin support 200 removed from hinge 18. FIG. 3 also shows how coupler 208 can be secured to eye 204 of hinge support 200 using gate 226. FIG. 3 further shows that coupler 208 can include a flat portion of frame 228 that can be configured to retain a resistance band having a flat profile.

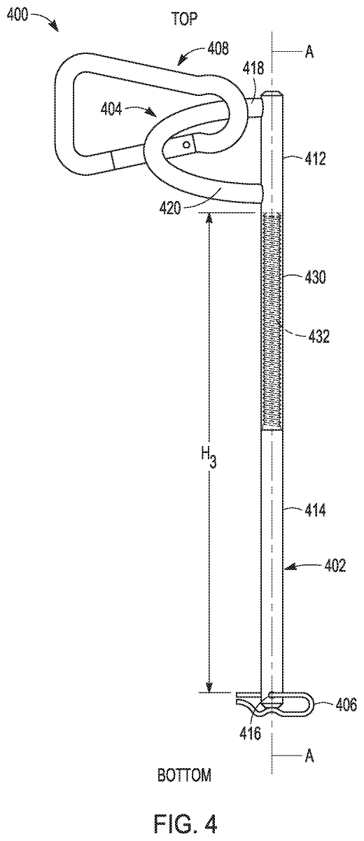

FIG. 4 illustrates an isometric view of pin support 400, in accordance with at least one example of this disclosure. Pin support 400 can include a two-piece construction allowing for a height adjustment of a body of pin support 400 relative to a hinge. Any of the previously discussed pin supports can be modified to include a two-piece construction.

Pin support 400 can include body 402, eye 404, fastener 406, and coupler 408. Body 402 can include top portion 412, bottom portion 414, and fastener bore 416. Eye 404 can include top arm 418 and bottom arm 420. Top portion 412 can include threaded female portion 430 and bottom portion 414 can include threaded male portion 432. Also shown in FIG. 4 are height H3, axis A, and orientation indicators Top and Bottom.

The components of pin support 400 can be similar to those of pin supports 100 and 200 discussed above, except that body 402 can be comprised of two pieces, top portion 412 and bottom portion 414. Top portion 412 can include female threaded portion 430, which can extend upward into top portion 412 from a bottom end of top portion 412 and can be a female threaded bore configured to receive male threaded portion 432 therein. Male threaded portion 432 can extend upward from a top end of bottom portion 414 and can be sized to threadably secure to threaded female portion 430. A threaded length of each of threaded female portion 430 and threaded male portion 432 can be significantly longer than is necessary to secure top portion 412 to bottom portion 414 such that height H3 of body 402 can be adjusted by threading threaded male portion 430 into and out of female threaded portion 430. In other examples, top portion 412 can be male threaded and bottom portion 414 can be female threaded.

In operation of some examples, a hinge pin can be removed from knuckles of a hinge and body 402 can be inserted into the knuckles (such as knuckles of hinge 18). If fastener bore 416 does not extend below a bottom knuckle of the hinge, body 402 can be removed and threaded female portion 430 and threaded male portion 432 can be partially unscrewed or unthreaded to increase height H3 between bottom arm 420 and fastener bore 416. Body 402 can then be reinserted into the hinge to check if fastener bore 416 is below a bottom knuckle of the hinge. This process can be repeated until fastener bore 416 is below a bottom knuckle of the hinge.

Alternatively, when fastener bore 416 is relatively far from a bottom knuckle of the hinge, threaded female portion 430 and threaded male portion 432 can be further screwed or threaded to decrease height H3 between bottom arm 420 and fastener bore 416 to bring fastener bore 416 closer to the bottom hinge knuckle. In this way, pin support 400 can provide a height adjustable pin that can be used with hinges having knuckle sets of various heights.

In other example, top portion 412 and bottom portion 414 can be inserted through opposite ends of the hinge and can be threadably secured once therein.

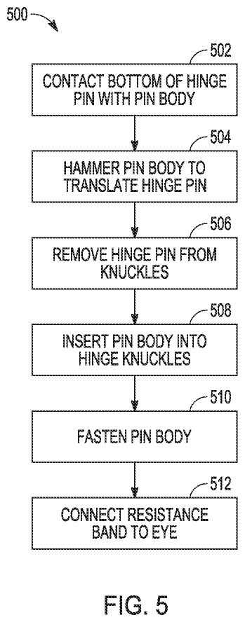

FIG. 5 illustrates a schematic of method 500, in accordance with at least one example of this disclosure. Method 500 can be a method of securing a pin support to a door. The steps or operations of method 500 are illustrated in a particular order for convenience and clarity; many of the discussed operations can be performed in a different sequence or in parallel without materially impacting other operations. Method 500 as discussed includes operations performed by multiple different actors, devices, and/or systems. It should be understood that subsets of the operations discussed in method 500 attributable to a single actor, device, or system could be considered a separate standalone process or method.

Method 500 can begin at step 502 where a body of a pin support can contact the bottom of a hinge pin. For example, bottom portion 214 of body 202 can be used to contact a bottom portion of a hinge pin. At step 504, a body of the pin support can be hammered, or otherwise forced upward, to translate the hinge pin with respect to knuckles of the hinge. For example, body 202 can be hammered through knuckles of hinge 218 to displace a hinge pin. At step 506, the hinge pin can be removed from the knuckles. Steps 502 through 506 are optional. For example, they can be performed using a tool other than the pin support or may not be performed (e.g., such as, in a new installation).

At step 508, the pin body can be inserted into the hinge knuckles. For example, body 202 can be inserted from top to bottom into knuckles of hinge 18. At step 510, a fastener can be secured to the body. For example, fastener 206 can be secured to bottom portion 214 of body 202 through fastener bore 216. Then, at step 512, a resistance band can be connected to an eye of the pin support. For example, resistance band 110 can be secured to eye 104.

In one example, a second end portion of a cylindrical body of a hinge pin support system can engage a hinge pin of a door hinge, where the cylindrical body can be hammered to translate the hinge pin. The hinge pin can be removed from knuckles of the door hinge and cylindrical body can be inserted into the knuckles of the door hinge.

In another example, a fastener can be secured to a second end portion of the pin body. In another example, a resistance band can be connected to an eye coupled to the first end portion of the cylindrical body.

### Examples

The following, non-limiting examples, detail certain aspects of the present subject matter to solve the challenges and provide the benefits discussed herein, among others.

Example 1 is a hinge pin support for a resistance band where the hinge pin support comprises: a cylindrical body extending along a longitudinal axis and including a first end portion and an opposite second end portion, the cylindrical body insertable into a set of knuckles of a door hinge; and an eye connectable to a resistance band, the eye coupled to the first end portion of the cylindrical body and extending radially outward from the cylindrical body; and a fastener securable to the second end portion of the cylindrical body to limit lateral translation of the cylindrical body relative to the set of knuckles.

In Example 2, the subject matter of Example 1 optionally includes the cylindrical body having a fastener bore extending through the second end portion of the cylindrical body substantially orthogonally to the longitudinal axis, the fastener bore configured to receive the fastener therein.

In Example 3, the subject matter of Example 2 optionally includes the fastener comprising a cotter pin including a head sized to allow the cotter pin to hang vertically from the fastener bore when the cotter pin head is inserted into the fastener bore.

In Example 4, the subject matter of any one or more of Examples 2-3 optionally includes the eye positioned on the cylindrical body to contact a top knuckle of the set of knuckles to limit downward translation of the cylindrical body with respect to the set of knuckles such that the eye is located above the top knuckle and the fastener bore is located below a bottom knuckle of the set of knuckles.

In Example 5, the subject matter of any one or more of Examples 2-4 optionally includes the fastener comprising a cotter pin securable to the fastener bore and engageable with the set of knuckles to limit lateral translation of the cylindrical body with respect to the set of knuckles.

In Example 6, the subject matter of any one or more of Examples 1-5 optionally includes the eye having a top arm coupled to a first end of the first end portion and a bottom arm coupled to the first portion below the first end.

In Example 7, the subject matter of Example 6 optionally includes the bottom arm configured to engage a top knuckle of the set of knuckles to limit downward translation of the cylindrical body relative to the set of knuckles.

In Example 8, the subject matter of Example 7 optionally includes the set of knuckles having knuckles of a first leaf and knuckles of a second leaf, wherein the cylindrical body is sized to secure knuckles of the first leaf to knuckles of the second leaf.

In Example 9, the subject matter of Example 8 optionally includes the cylindrical body being sized to rotate about the longitudinal axis while inserted in the set of knuckles.

In Example 10, the subject matter of any one or more of Examples 7-9 optionally includes the first end portion of the cylindrical body having a threaded female portion and the second end portion of the cylindrical body having a threaded male portion threadably securable to the threaded female portion to form the cylindrical body.

In Example 11, the subject matter of any one or more of Examples 7-10 optionally includes the threaded male portion being adjustably securable to threaded female portion to adjust a height of the cylindrical body.

Example 12 is a hinge pin support system for coupling a resistance band to a door hinge, where the hinge pin support system comprises: a hinge pin support comprising: a cylindrical body extending along a longitudinal axis and including a first end portion and an opposite second end portion, the cylindrical body insertable into a set of knuckles of a door hinge; and an eye connectable to a resistance band, the eye coupled to the first end portion of the cylindrical body and extending radially outward from the cylindrical body; and a coupler releasably securable to the eye and configured to releasably retain a resistance band therein.

In Example 13, the subject matter of Example 12 optionally includes a fastener securable to the second end portion of the cylindrical body to limit lateral translation of the cylindrical body relative to the set of knuckles.

In Example 14, the subject matter of any one or more of Examples 12-13 optionally includes the coupler comprising a carabiner configured to receive one of a plurality of resistance bands of various sizes.

In Example 15, the subject matter of any one or more of Examples 12-14 optionally includes the cylindrical body having a fastener bore extending through the second end portion of the cylindrical body substantially orthogonally to the longitudinal axis, the fastener bore being configured to receive the fastener therein, and the fastener comprising a cotter pin including a head sized to allow the cotter pin to hang vertically from the fastener bore when the cotter pin head is inserted into the fastener bore, the cotter pin engageable with the set of knuckles to limit lateral translation of the cylindrical body with respect to the set of knuckles.

In Example 16, the subject matter of Example 15 optionally includes the eye being positioned on the cylindrical body to contact a top knuckle of the set of knuckles to limit downward translation of the cylindrical body with respect to the set of knuckles such that the eye is located above the top knuckle and the fastener bore is located below a bottom knuckle of the set of knuckles.

In Example 17, the subject matter of any one or more of Examples 12-16 optionally includes the first end portion of the cylindrical body having a threaded female portion and the second end portion of the cylindrical body having a threaded male portion threadably securable to the threaded female portion to form the elongate body.

In Example 18, the subject matter of any one or more of Examples 12-17 optionally includes a door hinge.

Example 19 is a method of installing a pin hinge support system that includes: inserting a cylindrical body, having an eye at a first end portion and a bore at an opposite, second end portion, into the knuckles of the door hinge; securing a fastener to the second end portion of the pin body; and connecting a resistance band to the eye of the cylindrical body.

In Example 20, the subject matter of Example 19 optionally includes engaging a second end portion of the cylindrical body of the hinge pin support system with a hinge pin of a door hinge; hammering the cylindrical body to translate the hinge pin; and removing the hinge pin from knuckles of the door hinge.

In Example 21, the support, system, or method of any one of or any combination of Examples 1-20, is optionally configured such that all elements or options recited are available to use or select from.

### ADDITIONAL NOTES

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A hinge pin support for a resistance band, the hinge pin support comprising:
a cylindrical body extending along a longitudinal axis and including a first end portion and an opposite second end portion, the cylindrical body insertable into a set of knuckles of a door hinge; and
a closed-loop eye connectable to a resistance band, the eye coupled to the first end portion of the cylindrical body and extending radially outward from the cylindrical body; and
a fastener securable to the second end portion of the cylindrical body to limit lateral translation of the cylindrical body relative to the set of knuckles.

2. The hinge pin support of claim 1, wherein the cylindrical body includes a fastener bore extending through the second end portion of the cylindrical body substantially orthogonally to the longitudinal axis, the fastener bore configured to receive the fastener therein.

3. The hinge pin support of claim 2, wherein the fastener comprises a cotter pin including a head sized to allow the cotter pin to hang vertically from the fastener bore when the cotter pin head is inserted into the fastener bore.

4. The hinge pin support of claim 2, wherein the eye is positioned on the cylindrical body to contact a top knuckle of the set of knuckles to limit downward translation of the cylindrical body with respect to the set of knuckles such that the eye is located above the top knuckle and the fastener bore is located below a bottom knuckle of the set of knuckles.

5. The hinge pin support of claim 2, wherein the fastener comprises a cotter pin securable to the fastener bore and engageable with the set of knuckles to limit lateral translation of the cylindrical body with respect to the set of knuckles.

6. The hinge pin support of claim 1, wherein the eye includes a top arm coupled to a first end of the first end portion and a bottom arm coupled to the first portion below the first end.

7. The hinge pin support of claim 6, wherein the bottom arm is configured to engage a top knuckle of the set of knuckles to limit downward translation of the cylindrical body relative to the set of knuckles.

8. The hinge pin support of claim 7, wherein the set of knuckles includes a first leaf and a second leaf, wherein the cylindrical body is sized to secure knuckles of the first leaf to knuckles of the second leaf.

9. The hinge pin support of claim 8, wherein the cylindrical body is sized to rotate about the longitudinal axis while inserted in the set of knuckles.

10. The hinge pin support of claim 7, wherein the first end portion of the cylindrical body includes a threaded female portion and the second end portion of the cylindrical body includes a threaded male portion threadably securable to the threaded female portion to form the cylindrical body.

11. The hinge pin support of claim 10, wherein the threaded male portion is adjustably securable to threaded female portion to adjust a height of the cylindrical body.

12. A hinge pin support system for coupling a resistance band to a door hinge, comprising:
a hinge pin support comprising:
a cylindrical body extending along a longitudinal axis and including a first end portion and an opposite second end portion, the cylindrical body insertable into a set of knuckles of a door hinge, and a fastener bore extending through the second end portion of the cylindrical body orthogonally to the longitudinal axis; and
a closed-loop eye connectable to a resistance band, the eye coupled to the first end portion of the cylindrical body and extending radially outward from the cylindrical body; and
a coupler releasably securable to the eye and configured to releasably retain a resistance band therein;
wherein the eye is positioned on the cylindrical body to contact a top knuckle of the set of knuckles to limit downward translation of the cylindrical body with respect to the set of knuckles such that the eye is located above the top knuckle and the fastener bore is located below a bottom knuckle of the set of knuckles.

13. The hinge pin support system of claim 12, further comprising:
a fastener securable to the second end portion of the cylindrical body to limit lateral translation of the cylindrical body relative to the set of knuckles.

14. The hinge pin support system of claim 12, wherein the coupler comprises a carabiner configured to receive one of a plurality of resistance bands of various sizes.

15. The hinge pin support system of claim 12, wherein the fastener bore is configured to receive the fastener therein and wherein the fastener comprises a cotter pin including a head sized to allow the cotter pin to hang vertically from the fastener bore when the cotter pin head is inserted into the fastener bore, the cotter pin engageable with the set of knuckles to limit lateral translation of the cylindrical body with respect to the set of knuckles.

16. (canceled)

17. The hinge pin support system of claim 12, wherein the first end portion of the cylindrical body includes a threaded female portion and the second end portion of the cylindrical body includes a threaded male portion threadably securable to the threaded female portion to form the elongate body.

18. The hinge pin support of claim 12, further comprising a door hinge.

19. A method of installing a hinge pin support system, the method comprising:
inserting a cylindrical body, having a closed-loop eye at a first end portion and a bore at an opposite, second end portion, into the knuckles of the door hinge, wherein the eye is positioned on the cylindrical body to contact a top knuckle;
securing a fastener through the bore of the second end portion of the pin body, wherein the bore is positioned on the cylindrical body below a bottom knuckle; and
connecting a resistance band to the eye of the cylindrical body.

20. The method of claim 19, further comprising:
engaging a second end portion of the cylindrical body of the hinge pin support system with a hinge pin of a door hinge;
hammering the cylindrical body to translate the hinge pin; and
removing the hinge pin from knuckles of the door hinge.
